(19) United States
(12) Patent Application Publication
(10) Pub. No.: US 2001/0041945 A1
(43) Pub. Date: Nov. 15, 2001

(54) Sounding cup

(76) Inventors: Yuen Wing Lo, Kowloon (HK); Chi Hing Kwong, Kowloon (HK)

Correspondence Address: Adams, Schwartz & Evans, P.A., 2180 Two First Union Center, Charlotte, NC, 28282, US

(21) Appl. No.: 09/725,530

(22) Filed: Nov. 29, 2000

Related U.S. Application Data
(60) Provisional application No. 60/167,743, filed on Nov. 29, 1999.
(60) Provisional application No. 60/201,119, filed on May 2, 2000.

(51) Int. Cl. G06F 17/00; G10L 11/00; G10L 21/00

(52) U.S. Cl. 700/94; 381/61; 704/270; 704/272

(57) ABSTRACT

A novel and entertaining sounding cup includes a bottom and side wall defining a drinking vessel for holding a liquid. A sensor is formed with either of the bottom and side wall for detecting liquid disturbance in the vessel. A control circuit is operatively connected to the sensor and adapted for generating a signal output in response to liquid disturbance in the vessel. A loudspeaker is carried by either of the bottom and side wall, and is activated by the signal output for producing outwardly radiating acoustical energy in a frequency range sufficient to be heard by a user.

### TECHNICAL FIELD AND BACKGROUND OF INVENTION

This invention relates to a novel sounding cup. The invention is especially applicable for use and enjoyment by children. Although resembling a conventional drinking cup, the invention produces an entertaining sound in response to the stirring or drinking of a beverage contained in the cup. The sound may include a short melody, a funny voice or message, or other entertaining noise intended to amuse the user. In a further embodiment, the invention is a removable sounding base which is adapted to fit onto the bottom of a standard aluminum beverage can. When a user drinks the beverage, either through a straw or directly from the can, the sounding base produces an entertaining noise.

### SUMMARY OF THE INVENTION

Therefore, it is an object of the invention to provide a sounding cup which produces an entertaining sound in response to the stirring or drinking of a beverage contained in the cup.

It is another object of the invention to provide a sounding cup which utilizes a touchless and switchless circuit to activate a loudspeaker stored in the cup.

It is another object of the invention to provide a sounding cup which utilizes capacitance coupling to transfer energy from one electronic circuit to another.

It is another object of the invention to provide a sounding cup which employs a capacitance relay for triggering a signal output to activate the loudspeaker stored the cup.

It is another object of the invention to provide a sounding cup which employs an RC oscillator base capacitance level change detector.

It is another object of the invention to provide a sounding cup which will go into standby mode to save power consumption if no operation is detected.

It is another object of the invention to provide a sounding cup which produces an entertaining sound upon drinking a beverage contained in the cup through a straw.

It is another object of the invention to provide a sounding cup which includes a removable base which can be retrofitted onto conventional aluminum soda cans to produce an entertaining sound upon detecting a capacitance level change inside the can.

These and other objects of the present invention are achieved in the preferred embodiments disclosed below by providing a novel and entertaining sounding cup. The sounding cup includes a bottom and side wall defining a drinking vessel for holding a liquid. A sensor is formed with either of the bottom and side wall for detecting liquid disturbance in the vessel. A control circuit is operatively connected to the sensor and adapted for generating a signal output in response to liquid disturbance in the vessel. A loudspeaker is carried by either of the bottom and side wall, and is activated by the signal output for producing outwardly radiating acoustical energy in a frequency range sufficient to be heard by a user.

According to another preferred embodiment of the invention, the bottom is formed by a removable base defining a recessed compartment for storing the loudspeaker.

According to another preferred embodiment of the invention, a battery cooperates with the signal output to operate the loudspeaker.

According to another preferred embodiment of the invention, the side wall is formed of plastic.

According to another preferred embodiment of the invention, a radio magnetic frequency shield is embedded in the plastic side wall to protect the sensor from external interference.

In another embodiment, the invention is a novel and entertaining sounding cup which includes a bottom and side wall defining a drinking vessel for holding a liquid. A sensor is formed with either of the bottom and side wall. The sensor includes a clock signal defining a base level capacitance in the vessel. A control circuit is operatively connected to the sensor and is adapted for generating a signal output in response to a threshold change in the base level capacitance. A loudspeaker is carried by either of the bottom and side wall, and is activated by the signal output for producing outwardly radiating acoustical energy in a frequency range sufficient to be heard by a user.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is a sectional view of a sounding cup according to one preferred embodiment of the invention, and showing the base the cup removed;

FIG. 2 is a plan view showing the interior components of the sound unit compartment defined by the base of the cup;

FIG. 3 is a schematic illustrating the electronics of the circuit board;

FIG. 4 is a diagram of the control circuit;

FIG. 5 is a block diagram of the control circuit;

FIG. 6 is a chart of signal illustrating operation of the sounding cup; and

FIG. 7 is a cross sectional view illustrating a further embodiment of the sounding cup.

### DESCRIPTION OF THE PREFERRED EMBODIMENT AND BEST MODE

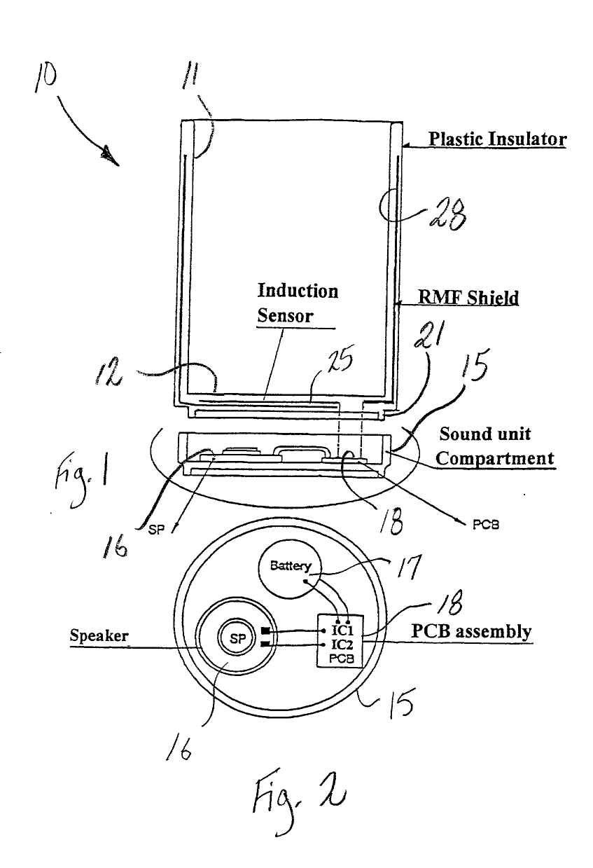

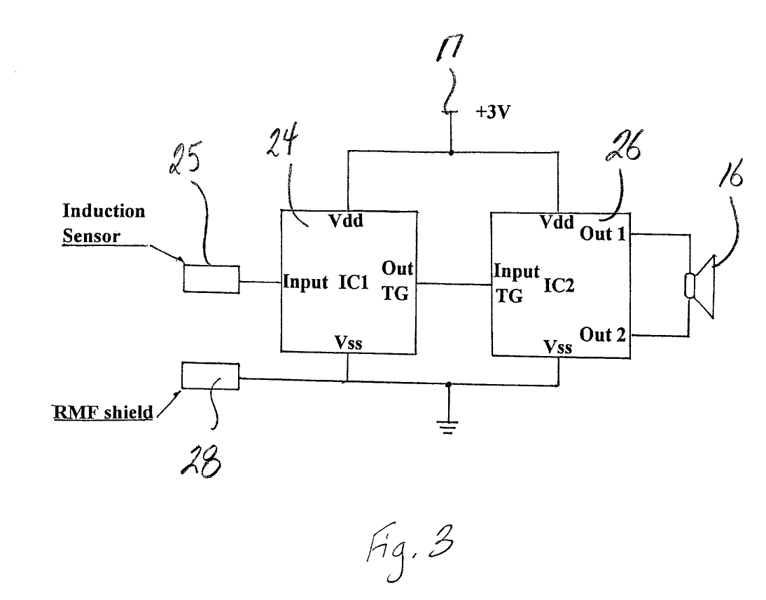

Referring now specifically to the drawings, a sounding cup according to the present invention is illustrated in FIG. 1 and shown generally at reference numeral 10. The sounding cup 10 includes a cylindrical side wall 11 having a closed bottom 12 forming a drinking vessel suitable for holding a beverage, and a removable base 15 attached to the side wall 11 adjacent the closed bottom 12. As shown in FIGS. 1 and 2, the base 15 forms a recessed compartment for holding a loudspeaker 16, battery 17, and circuit board 18. The side wall 11 preferably includes a bottom annular protruding rim 21 formed with the closed bottom 12, and having an outside diameter slightly less than an inside diameter of the base 15. The base 15 and side wall 11 are joined together using mating screw threads, friction engagement, or other suitable attachment means.

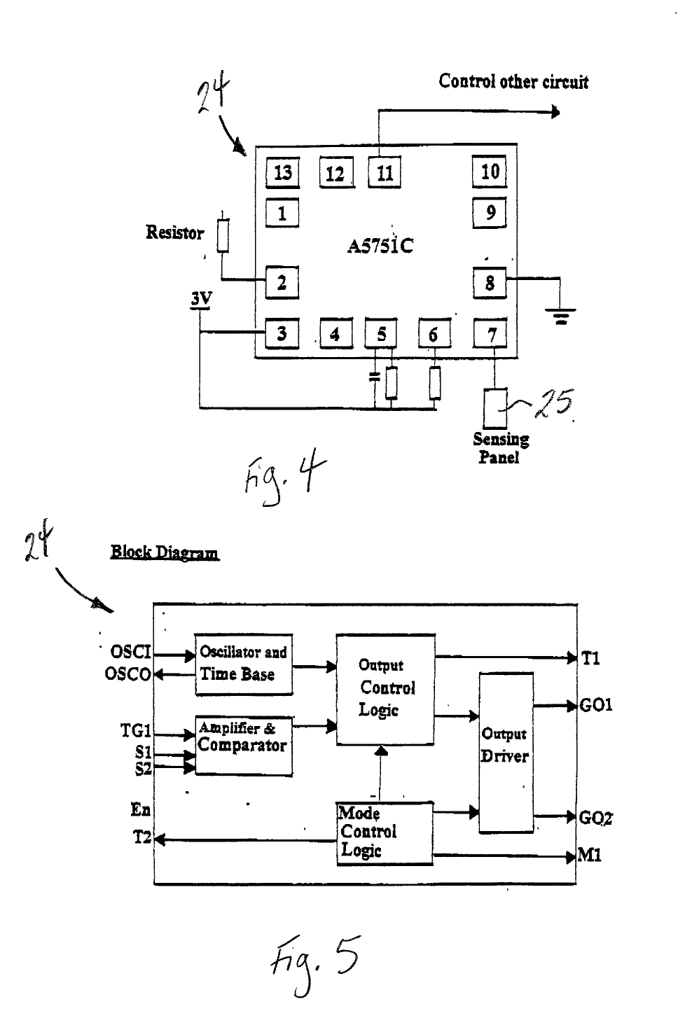

Referring to FIG. 3, 4, and 5, the circuit board 18 includes a control circuit 24 communicating with a conductive plate 25 encapsulated in the closed bottom 12 of the sounding cup 10, and a sound output circuit 26 operatively connected to the control circuit 24, battery 17, and loudspeaker 16. The conductive plate 25 and liquid contained in the sounding cup 10 form respective electrodes insulated from each other by a dielectric created by the closed bottom 12. The resulting assembly forms a capacitor which is used to couple capacitance changing inside the sounding cup 10. A radio magnetic frequency shield 28 is embedded in the side wall 11 to prevent external signal interference.

A self generated clock signal or other suitable capacitance measuring device is used to generate a base level capacitance inside the sounding cup 10. The capacitance level changes a result of liquid disturbance caused by, for example, drinking or stirring the liquid beverage. This change is indicated by means of a phase shift or amplitude change in the clock signal. In one application, a twenty to fifty percent change in amplitude represents a threshold capacitance change. Thus, if the battery power supply is 3V and the clock frequency is 26 Khz with a base signal level of 1.7V per phase, then a threshold capacitance change would occur at 1.3V per phase. Upon occurrence of a capacitance change in the sounding cup 10, the new level of capacitance is coupled to the conductive plate 25 and fed to the control circuit 24. The capacitance is then amplified and compared to the base level capacitance. If the capacitance change is sufficient to meet or exceed the predetermined threshold, then a signal output is transmitted from the control circuit 24 to the sound output circuit 26. The sound output circuit 26 cooperates with the battery charge to activate the loudspeaker 16 which produces an entertaining, audible sound to the user.

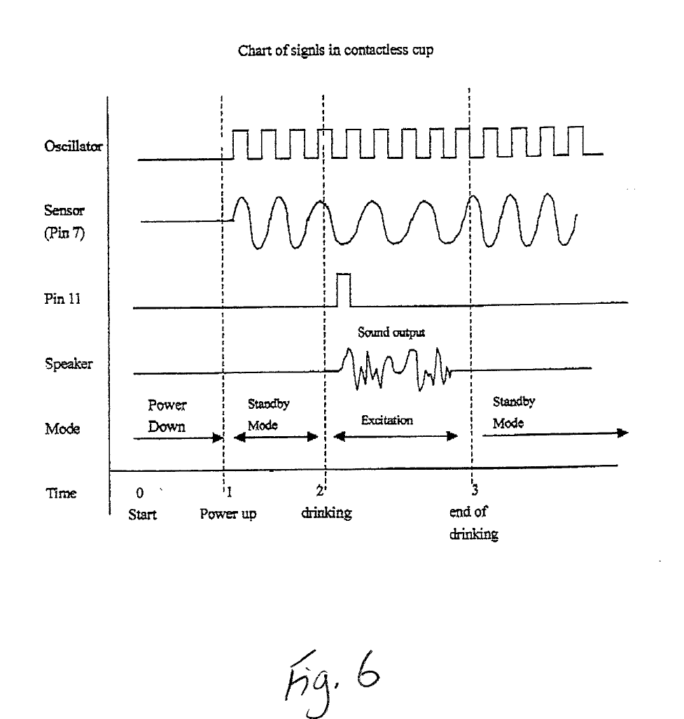

The pad description for the diagrams of FIGS. 4 and 5 is provided below.

| Number | Name | Description |
|---|---|---|
| 1 | OSCI | Oscillator Input |
| 2 | OSCO | Oscillator Output |
| 3 | VDD | Power Supply |
| 4 | T1 | Test Pin 1 |
| 5 | S1 | Sensitivity Adjust 1 |
| 6 | S2 | Sensitivity Adjust 2 |
| 7 | TG1 | Capacitance Sensor |
| 8 | VSS | Ground |
| 9 | En | Chip Enable |
| 10 | T2 | Test Pin 2 |
| 11 | GO1 | Positive Pulse Output |
| 12 | GO2 | Negative Pulse Output |
| 13 | M1 | Mode Indicator |

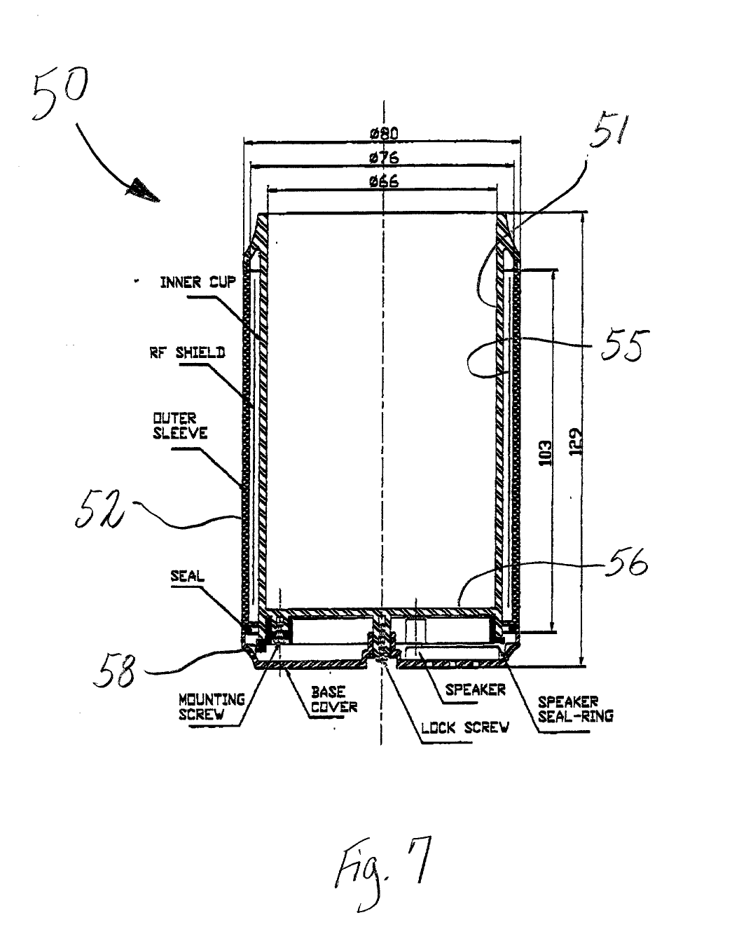

A chart of signals illustrating operation of the sounding cup 10 is provided in FIG. 6. From a power down mode, upon grasping the sounding cup with the hand, the control circuit moves into standby mode. When the beverage consumed by the user, the control circuit signals the sound output circuit to activate the loudspeaker creating the entertaining sound output. After drinking, the control circuit moves back into standby mode and then into the power down mode.

A further embodiment of the invention is shown in FIG. 7. The sounding cup 50 includes inner and outer cylindrical side walls 51 and 52 defining a hollow housing for storing a cylindrical radio magnetic frequency shield 55. A bottom wall 56 is integrally formed with the inner side wall 51 to create a sealed drinking vessel suitable for holding a liquid. The base 58 defines a recessed cavity for storing the electronic components, described above, which cooperate to effect operation of the sounding cup 50. The base 58 is removably attached using a lock screw or other suitable attachment means.

A sounding cup is described above. Various details of the invention may be changed without departing from its scope. Furthermore, the foregoing description of the preferred embodiment of the invention and the best mode for practicing the invention are provided for the purpose of illustration only and not for the purpose of limitation-the invention being defined by the claims.

We claim:

1. A sounding cup, comprising:
(a) a bottom and side wall joined together to form a drinking vessel for holding a liquid;
(b) a sensor formed with either of said bottom and side walls for detecting liquid disturbance in said vessel;
(c) a control circuit operatively connected to said sensor and adapted for generating a signal output in response to liquid disturbance in said vessel; and
(d) a loudspeaker carried by either of said bottom and side wall, and activated by said signal output for producing outwardly radiating acoustical energy in a frequency range sufficient to be heard by a user.

2. A sounding cup according to claim 1, wherein said bottom comprises a removable base defining a compartment for storing said loudspeaker.

3. A sounding cup according to claim 1, and comprising a battery cooperating with said signal output to operate said loudspeaker.

4. A sounding cup according to claim 1, wherein said side wall is formed of plastic.

5. A sounding cup according to claim 4, and comprising a radio magnetic frequency shield embedded in said plastic side wall to protect said sensor from external interference.

6. A sounding cup, comprising:
(a) a bottom and side wall joined together to form a drinking vessel for holding a liquid;
(b) a sensor formed with either of said bottom and side wall, and comprising a clock signal defining a base level capacitance in said vessel;
(c) a control circuit operatively connected to said sensor and adapted for generating a signal output in response to a threshold change in said base level capacitance; and
(d) a loudspeaker carried by either of said bottom and side wall, and activated by said signal output for producing outwardly radiating acoustical energy in a frequency range sufficient to be heard by a user.
